(19) United States
(12) Patent Application Publication
(10) Pub. No.: US 2026/0093626 A1
(43) Pub. Date: Apr. 2, 2026

(54) FAST WARMUP OF PROCESSOR CACHE

(71) Applicant: Nokia Solutions and Networks Oy, Espoo (FI)

(72) Inventor: Pranjal Kumar Dutta, Sunnyvale, CA (US)

(21) Appl. No.: 18/904,595

(22) Filed: Oct. 2, 2024

(51) Int. Cl. G06F 12/0802

(52) U.S. Cl. CPC G06F 12/0802; G06F 2212/452

(57) ABSTRACT

Various example embodiments of a capability for supporting fast warmup of a processor cache are presented. The processor cache may be a processor-side cache that is disposed within a processing unit (e.g., a cache within a processor of the processing unit, a cache within the processing unit where the cache is shared by multiple processors of the processing unit, or the like). The fast warmup of the processor cache may be supported based on a persistent memory. The fast warmup of the processor cache may be supported based on a persistent memory by storing the contents of the processor cache from the processor cache into the persistent memory based on a reset of the processing unit and storing the contents of the processor cache from the persistent memory into the processor cache based on a restart of the processing unit.

### TECHNICAL FIELD

Various example embodiments relate generally to computing systems and, more particularly but not exclusively, to supporting fast warmup of a processor cache in a computing system.

### BACKGROUND

Computing systems utilize various types of processors to perform various functions in various contexts.

### SUMMARY

In at least some example embodiments, an apparatus includes a processing unit, the processing unit including a cache configured to store a set of cache lines and a controller configured to control storage of the set of cache lines from the cache into a persistent memory based on a reset of the processing unit and control storage of the set of cache lines from the persistent memory into the cache based on a restart of the processing unit. In at least some example embodiments, the processing unit includes a processor, and the cache is disposed on the processor. In at least some example embodiments, the processing unit includes a set of multiple processors, and the cache is configured to be shared by the set of multiple processors. In at least some example embodiments, the cache includes at least one of a Level 1 (L1) cache, a Level 2 (L2) cache, or a Level 3 (L3) cache. In at least some example embodiments, the storage of the set of cache lines from the cache into the persistent memory and the storage of the set of cache lines from the persistent memory into the cache are controlled based on a communication bus. In at least some example embodiments, the communication bus includes an I2C (I2C) bus or a Serial Peripheral Interface (SPI) bus. In at least some example embodiments, the storage of the set of cache lines from the cache into the persistent memory and the storage of the set of cache lines from the persistent memory into the cache are controlled based on interaction by the controller with a bus controller of the communication bus. In at least some example embodiments, the apparatus further includes the persistent memory, and the persistent memory is configured to receive the set of cache lines from the processing unit based on the reset of the processing unit, store the set of cache lines from the cache, and send the set of cache lines to the processing unit based on the restart of the processing unit. In at least some example embodiments, the apparatus further includes a main memory configured to store instructions and data for the processing unit. In at least some example embodiments, the apparatus further includes a power source configured to power the processing unit, and the storage of the set of cache lines from the cache into the persistent memory is initiated based on an unavailability of the power source and the storage of the set of cache lines from the persistent memory into the cache is initiated based on an availability of the power source. In at least some example embodiments, the apparatus further includes a backup power source configured to power the cache and the controller during the storage of the set of cache lines from the cache into the persistent memory. In at least some example embodiments, the backup power source includes a battery, a capacitor, or a supercapacitor. In at least some example embodiments, the persistent memory includes at least one of an electrically erasable programmable read only memory (EEPROM), a hard disk drive (HDD), a solid state drive (SSD), a secure digital (SD) card, or an embedded multimedia (eMMC) card. In at least some example embodiments, the set of cache lines is stored in the persistent memory as a set of key-value pairs, respectively, and, for each cache line in the set of cache lines, the respective key-value pair for the respective cache line includes a key identifying a respective location of the respective cache line within the cache and a value comprising a respective set of contents of the respective cache line within the cache. In at least some example embodiments, the respective set of contents of the respective cache line includes a respective memory block of the respective cache line and a respective set of metadata of the respective cache line. In at least some example embodiments, to control the storage of the set of cache lines from the cache into the persistent memory based on the reset of the processing unit, the controller is configured to, for each cache line in the set of cache lines: create a key indicative of a location of the cache line within the cache, create a value including contents of the cache line, control storage of the key and the value in the persistent memory as a key-value pair for the cache line at a location within the persistent memory that is based on an offset byte parameter of the persistent memory, and increment the offset byte parameter of the persistent memory by a size of the key-value pair for the cache line. In at least some example embodiments, to control the storage of the set of cache lines from the persistent memory into the cache based on the restart of the processing unit, the controller is configured to, for each cache line in the set of cache lines: access a key-value pair for the cache line from a location within the persistent memory that is based on an offset byte parameter of the persistent memory, determine, from a key of the key-value pair, a location of the cache line within the cache, store, based on the location of the cache line within the cache, a value of the key-value pair from the persistent memory into the cache line within the cache, and increment the offset byte parameter of the persistent memory by a size of the key-value pair for the cache line. In at least some example embodiments, the set of cache lines includes a subset of available cache lines of the cache satisfying a condition. In at least some example embodiments, the condition includes metadata of a given cache line being indicative that a memory block held by the given cache line has nonvolatile addressing that prevents relocation of the memory block in a main memory after the reset of the processing unit. In at least some example embodiments, the condition is true for at least one of a program instruction or a packet forwarding table. In at least some example embodiments, the controller includes a cache warmup engine configured to control the storage of the set of cache lines from the cache into the persistent memory based on the reset of the processing unit and control the storage of the set of cache lines from the persistent memory into the cache based on the restart of the processing unit. In at least some example embodiments, the cache warmup engine includes: a backup agent configured to control the storage of the set of cache lines from the cache into the persistent memory based on the reset of the processing unit and a restore agent configured to control the storage of the set of cache lines from the persistent memory into the cache based on the restart of the processing unit. In at least some example embodiments, the processing unit includes a central processing unit (CPU), a graphics processing unit (GPU), or a network processing unit (NPU).

In at least some example embodiments, a method includes maintaining a set of cache lines in a cache of a processing unit, controlling storage of the set of cache lines from the cache into a persistent memory based on a reset of the processing unit, and controlling storage of the set of cache lines from the persistent memory into the cache based on a restart of the processing unit. In at least some example embodiments, the processing unit includes a processor, and the cache is disposed on the processor. In at least some example embodiments, the processing unit includes a set of multiple processors, and the cache is configured to be shared by the set of multiple processors. In at least some example embodiments, the cache includes at least one of a Level 1 (L1) cache, a Level 2 (L2) cache, or a Level 3 (L3) cache. In at least some example embodiments, the storing of the set of cache lines from the cache into the persistent memory and the storing of the set of cache lines from the persistent memory into the cache are controlled based on a communication bus. In at least some example embodiments, the communication bus includes an I²C (I2C) bus or a Serial Peripheral Interface (SPI) bus. In at least some example embodiments, the storing of the set of cache lines from the cache into the persistent memory and the storing of the set of cache lines from the persistent memory into the cache are controlled based on interaction by the controller with a bus controller of the communication bus. In at least some example embodiments, the method includes receiving, by the persistent memory, the set of cache lines from the processing unit based on the reset of the processing unit, storing, by the persistent memory, the set of cache lines from the cache, and sending, by the persistent memory, the set of cache lines to the processing unit based on the restart of the processing unit. In at least some example embodiments, the method includes storing, by a main memory, instructions and data for the processing unit. In at least some example embodiments, the method includes powering, by a power source, the processing unit, and the storage of the set of cache lines from the cache into the persistent memory is initiated based on an unavailability of the power source and the storage of the set of cache lines from the persistent memory into the cache is initiated based on an availability of the power source. In at least some example embodiments, the method includes powering, by a backup power source, the cache and the controller during the storage of the set of cache lines from the cache into the persistent memory. In at least some example embodiments, the backup power source includes a battery, a capacitor, or a supercapacitor. In at least some example embodiments, the persistent memory includes at least one of an electrically erasable programmable read only memory (EEPROM), a hard disk drive (HDD), a solid state drive (SSD), a secure digital (SD) card, or an embedded multimedia (eMMC) card. In at least some example embodiments, the set of cache lines is stored in the persistent memory as a set of key-value pairs, respectively, and, for each cache line in the set of cache lines, the respective key-value pair for the respective cache line includes a key identifying a respective location of the respective cache line within the cache and a value comprising a respective set of contents of the respective cache line within the cache. In at least some example embodiments, the respective set of contents of the respective cache line includes a respective memory block of the respective cache line and a respective set of metadata of the respective cache line. In at least some example embodiments, controlling the storage of the set of cache lines from the cache into the persistent memory based on the reset of the processing unit includes, for each cache line in the set of cache lines: creating a key indicative of a location of the cache line within the cache, creating a value including contents of the cache line, controlling storage of the key and the value in the persistent memory as a key-value pair for the cache line at a location within the persistent memory that is based on an offset byte parameter of the persistent memory, and incrementing the offset byte parameter of the persistent memory by a size of the key-value pair for the cache line. In at least some example embodiments, controlling the storage of the set of cache lines from the persistent memory into the cache based on the restart of the processing unit includes, for each cache line in the set of cache lines: accessing a key-value pair for the cache line from a location within the persistent memory that is based on an offset byte parameter of the persistent memory, determining, from a key of the key-value pair, a location of the cache line within the cache, storing, based on the location of the cache line within the cache, a value of the key-value pair from the persistent memory into the cache line within the cache, and incrementing the offset byte parameter of the persistent memory by a size of the key-value pair for the cache line. In at least some example embodiments, the set of cache lines includes a subset of available cache lines of the cache satisfying a condition. In at least some example embodiments, the condition includes metadata of a given cache line being indicative that a memory block held by the given cache line has nonvolatile addressing that prevents relocation of the memory block in a main memory after the reset of the processing unit. In at least some example embodiments, the condition is true for at least one of a program instruction or a packet forwarding table. In at least some example embodiments, controlling the storage of the set of cache lines from the cache into the persistent memory based on the reset of the processing unit and controlling the storage of the set of cache lines from the persistent memory into the cache based on the restart of the processing unit is performed by a cache warmup engine of the processing unit. In at least some example embodiments, the cache warmup engine includes: a backup agent configured to control the storage of the set of cache lines from the cache into the persistent memory based on the reset of the processing unit and a restore agent configured to control the storage of the set of cache lines from the persistent memory into the cache based on the restart of the processing unit. In at least some example embodiments, the processing unit includes a central processing unit (CPU), a graphics processing unit (GPU), or a network processing unit (NPU).

In at least some example embodiments, an apparatus includes means for maintaining a set of cache lines in a cache of a processing unit, means for controlling storage of the set of cache lines from the cache into a persistent memory based on a reset of the processing unit, and means for controlling storage of the set of cache lines from the persistent memory into the cache based on a restart of the processing unit. In at least some example embodiments, the processing unit includes a processor, and the cache is disposed on the processor. In at least some example embodiments, the processing unit includes a set of multiple processors, and the cache is configured to be shared by the set of multiple processors. In at least some example embodiments, the cache includes at least one of a Level 1 (L1) cache, a Level 2 (L2) cache, or a Level 3 (L3) cache. In at least some example embodiments, the storing of the set of cache lines from the cache into the persistent memory and the storing of the set of cache lines from the persistent memory into the cache are controlled based on a communication bus. In at least some example embodiments, the communication bus includes an I²C (I2C) bus or a Serial Peripheral Interface (SPI) bus. In at least some example embodiments, the storing of the set of cache lines from the cache into the persistent memory and the storing of the set of cache lines from the persistent memory into the cache are controlled based on interaction by the controller with a bus controller of the communication bus. In at least some example embodiments, the apparatus includes means for receiving, by the persistent memory, the set of cache lines from the processing unit based on the reset of the processing unit, means for storing, by the persistent memory, the set of cache lines from the cache, and means for sending, by the persistent memory, the set of cache lines to the processing unit based on the restart of the processing unit. In at least some example embodiments, the apparatus includes means for storing, by a main memory, instructions and data for the processing unit. In at least some example embodiments, the apparatus includes means for powering, by a power source, the processing unit, and the storage of the set of cache lines from the cache into the persistent memory is initiated based on an unavailability of the power source and the storage of the set of cache lines from the persistent memory into the cache is initiated based on an availability of the power source. In at least some example embodiments, the apparatus includes means for powering, by a backup power source, the cache and the controller during the storage of the set of cache lines from the cache into the persistent memory. In at least some example embodiments, the backup power source includes a battery, a capacitor, or a supercapacitor. In at least some example embodiments, the persistent memory includes at least one of an electrically erasable programmable read only memory (EEPROM), a hard disk drive (HDD), a solid state drive (SSD), a secure digital (SD) card, or an embedded multimedia (eMMC) card. In at least some example embodiments, the set of cache lines is stored in the persistent memory as a set of key-value pairs, respectively, and, for each cache line in the set of cache lines, the respective key-value pair for the respective cache line includes a key identifying a respective location of the respective cache line within the cache and a value comprising a respective set of contents of the respective cache line within the cache. In at least some example embodiments, the respective set of contents of the respective cache line includes a respective memory block of the respective cache line and a respective set of metadata of the respective cache line. In at least some example embodiments, the means for controlling the storage of the set of cache lines from the cache into the persistent memory based on the reset of the processing unit includes means for, for each cache line in the set of cache lines: creating a key indicative of a location of the cache line within the cache, creating a value including contents of the cache line, controlling storage of the key and the value in the persistent memory as a key-value pair for the cache line at a location within the persistent memory that is based on an offset byte parameter of the persistent memory, and incrementing the offset byte parameter of the persistent memory by a size of the key-value pair for the cache line. In at least some example embodiments, the means for controlling the storage of the set of cache lines from the persistent memory into the cache based on the restart of the processing unit includes means for, for each cache line in the set of cache lines: accessing a key-value pair for the cache line from a location within the persistent memory that is based on an offset byte parameter of the persistent memory, determining, from a key of the key-value pair, a location of the cache line within the cache, storing, based on the location of the cache line within the cache, a value of the key-value pair from the persistent memory into the cache line within the cache, and incrementing the offset byte parameter of the persistent memory by a size of the key-value pair for the cache line. In at least some example embodiments, the set of cache lines includes a subset of available cache lines of the cache satisfying a condition. In at least some example embodiments, the condition includes metadata of a given cache line being indicative that a memory block held by the given cache line has nonvolatile addressing that prevents relocation of the memory block in a main memory after the reset of the processing unit. In at least some example embodiments, the condition is true for at least one of a program instruction or a packet forwarding table. In at least some example embodiments, the means for controlling the storage of the set of cache lines from the cache into the persistent memory based on the reset of the processing unit and controlling the storage of the set of cache lines from the persistent memory into the cache based on the restart of the processing unit includes a cache warmup engine of the processing unit. In at least some example embodiments, the cache warmup engine includes: a backup agent configured to control the storage of the set of cache lines from the cache into the persistent memory based on the reset of the processing unit and a restore agent configured to control the storage of the set of cache lines from the persistent memory into the cache based on the restart of the processing unit. In at least some example embodiments, the processing unit includes a central processing unit (CPU), a graphics processing unit (GPU), or a network processing unit (NPU).

### BRIEF DESCRIPTION OF THE DRAWINGS

The teachings herein can be readily understood by considering the following detailed description in conjunction with the accompanying drawings, in which:

FIG. 1 depicts an example embodiment of a multi-processor system configured to support fast warmup of a processor cache of a processing unit, based on use of a persistent memory, when the processing unit resets and restarts;

FIG. 2 depicts an example embodiment of the multi-processor system of FIG. 1 for illustrating the state of the multi-processor system during storing of contents of the processor cache from the processor cache into the persistent memory based on the reset of the processing unit;

FIG. 3 depicts an example embodiment of the multi-processor system of FIG. 1 for illustrating the state of the multi-processor system after the storing of contents of the processor cache from the processor cache into the persistent memory based on the reset of the processing unit;

FIG. 4 depicts an example embodiment of the multi-processor system of FIG. 1 for illustrating the state of the multi-processor system before the storing of contents of the processor cache from the persistent memory into the processor cache based on the restart of the processing unit;

FIG. 5 depicts an example embodiment of the multi-processor system of FIG. 1 for illustrating the state of the multi-processor system during storing of contents of the processor cache from the persistent memory into the processor cache based on the restart of the processing unit;

FIG. 6 depicts an example embodiment of a method for use by a cache warmup engine to store cache lines of a processor cache of the processing unit from the processor cache into a persistent memory;

FIG. 7 depicts an example embodiment of a method for use by a backup agent of a cache warmup engine of a processing unit to store cache lines of a processor cache of the processing unit from the processor cache into a persistent memory;

FIG. 8 depicts an example embodiment of a method for use by a cache warmup engine to reinstate cache lines of a processor cache of the processing unit from a persistent memory into the processor cache;

FIG. 9 depicts an example embodiment of a method for use by a restore agent of a cache warmup engine of a processing unit to reinstate cache lines of a processor cache of the processing unit from a persistent memory into the processor cache;

FIG. 10 depicts an example embodiment of a method for supporting fast warmup of a processor cache of a processing unit, based on use of a persistent memory, when the processing unit resets and restarts; and

FIG. 11 depicts an example embodiment of a computer suitable for use in performing various functions presented herein.

To facilitate understanding, identical reference numerals have been used herein, wherever possible, in order to designate identical elements that are common among the various figures.

### DETAILED DESCRIPTION

Various example embodiments of a capability for supporting fast warmup of a processor cache are presented. The processor cache may be a processor-side cache that is disposed within a processing unit (e.g., a cache within a processor of the processing unit, a cache within the processing unit where the cache is shared by multiple processors of the processing unit, or the like). The fast warmup of the processor cache may be supported based on a persistent memory. The fast warmup of the processor cache may be supported based on a persistent memory by storing the contents of the processor cache from the processor cache into the persistent memory based on a reset of the processing unit and storing the contents of the processor cache from the persistent memory into the processor cache based on a restart of the processing unit. The persistent memory, which is configured to maintain the contents of the processor cache without input power, may be an electrically erasable programmable read only memory (EEPROM), a hard disk drive (HDD), a solid state drive (SSD), a secure digital (SD) card, an embedded multimedia (eMMC) card, or the like. The contents of the processor cache which are stored into the persistent memory based on the reset and stored back into the processor cache based on the restart may include valid cache lines of the processor cache, which may be maintained within the persistent memory as key-value pairs for the valid cache lines (e.g., the key indicates the identity of the cache line (e.g., {set number, way number} in a N-way set associative cache) and the value includes the cached memory block and the metadata of the cache line (e.g., tags or other metadata)). The fast warmup of the processor cache may be controlled by a cache warmup engine (CWE) within the processing unit, where the CWE may include a backup agent configured to store the valid cache lines of the processor cache from the processor cache into the persistent memory and a restore agent configured to reinstate the preserved cache lines from the persistent memory back into the processor cache. The processor cache and the CWE may be connected to a backup power source (e.g., a battery, a capacitor, a supercapacitor, or the like) which may temporarily power the processor cache and the CWE, in the event that the main power to the processing unit is interrupted (e.g., during a cold reset of the processing unit) while the contents of the processor cache are preserved in the persistent memory. In this manner, the capability for supporting fast warmup of a processor cache ensures preservation of the state of the processor cache upon a reset of the processing unit and accurate reinstatement of the state of the processor cache, as it was prior to the reset of the processing unit, after a restart of the processing unit. It will be appreciated that these and various other example embodiments of the capability for supporting fast warmup of a processor cache may be further understood by way of reference to the various figures, which are discussed further below.

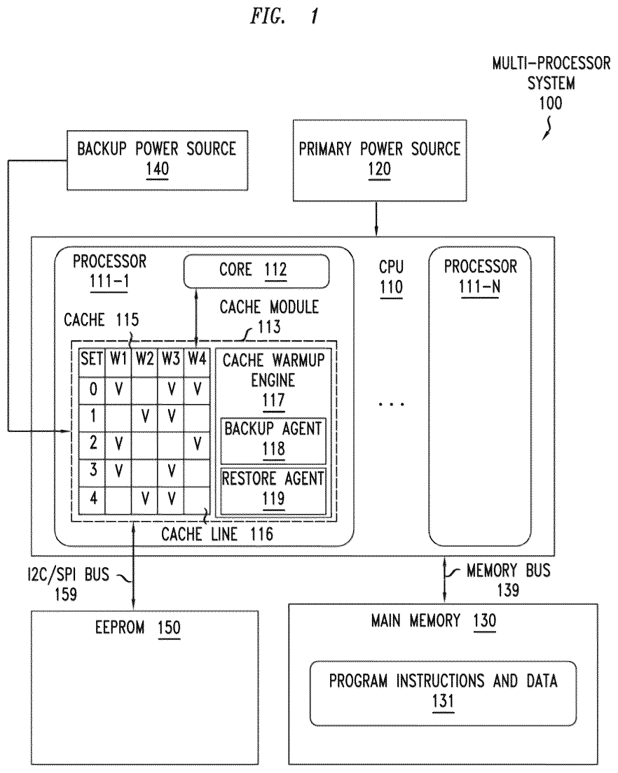

FIG. 1 depicts an example embodiment of a multi-processor system configured to support fast warmup of a processor cache of a processing unit, based on use of a persistent memory, when the processing unit resets and restarts.

As illustrated in FIG. 1, a multi-processor system 100 is provided. The multi-processor system 100 is configured to support fast warmup of processor caches of the CPU 110 in response to a cold/warm reset/restart of the CPU 110. The multi-processor system 100, as discussed further below, is configured to support fast warmup of caches of the CPU 110, in response to a cold/warm reset/restart of the CPU 110, based on use of a persistent memory to store contents of processor caches of the CPU 110 during the cold/warm reset/restart of the CPU 110 and a backup power source to provide power sufficient to support transfer of contents of processor caches of the CPU 110 from processor caches of the CPU 110 to the persistent memory during the cold/warm reset/restart of the CPU 110. As depicted in FIG. 1, the multi-processor system 100 includes a central processing unit (CPU) 110, a primary power source 120 configured to power the CPU 110, a main memory 130 supporting the CPU 110, a backup power source 140 configured to provide backup power for certain elements involved in fast warmup of processor caches of the CPU 110, and an electrically erasable programmable read only memory (EEPROM) 150 configured to provide a persistent backup memory for fast warmup of caches of the CPU. It will be appreciated that the multi-processor system 100 may include various other elements which have been omitted for purposes of clarity.

The CPU 110, as indicated above, may experience a cold or warm reset/restart event, and fast warmup of caches of the CPU 110 in response to a cold/warm reset/restart of the CPU 110 is supported. With respect to resets, it will be appreciated that a cold reset of the CPU 110 means loss of power from the primary power source 120, whereas a warm reset of the CPU 110 means that the CPU 110 does not lose power, but, rather, is reset to restart its operations afresh. For example, a warm reset can be user triggered, such as where a user issues a command through the operating system software that would trigger reset by programming a register in the CPU 110. With respect to restarts, it is noted that, after the CPU 110 resumes its operation after a restart, the execution of program instructions and access to its data would gradually warm up caches of the CPU as the result of cache misses (the CPU 110 will attempt to look up the program instructions in the caches and, if not found, then will retrieve the program instructions from the main memory 130). These cache misses result in slower execution of the program until the caches are completely warmed, thereby impacting the performance of the CPU 110 and, thus, the application(s) of the CPU 110 (e.g., graphics processing, network packet processing, or the like). For example, in case of packet processing, all packets would suffer higher latency until the caches are completely warmed (and, in certain packet flows, delayed delivery of packets is actually worse than dropped packets). For simplicity and without the loss of generality, example embodiments are primarily illustrated herein with respect to a cold reset/restart of the CPU 110 due to loss of power from the primary power source 120, but it will be appreciated that these example embodiments may be applied to support warm resets/restarts of the CPU 110 as well.

The CPU 110 includes a set of processors 111-1-111-N (collectively, processors 111), each of the processors 111 being configured as illustrated for the processor 111-1 although the details of the other processors 111-2-111-N are omitted for purposes of clarity. Namely, the processor 111-1 includes a core 112 and a cache module 113 supporting the core 112 and, again, it will be appreciated that, although omitted for purposes of clarity, each of the other processors also will include cores and cache modules, respectively. The processor cores of the processors 111 may be arranged to support various parallel processing functions. It will be appreciated that the CPU 110 may include various numbers of processors 111 and, thus, various number of processor cores of the processors 111 (e.g., 2 processor cores, 4 processor cores, 8 processor cores, 16 processor cores, 32 processor cores, 64 processor cores, 128 processor cores, 256 processor cores, 512 processor cores, 1000 processor cores, 2000 processor cores, 4000 processor cores, 8000 processor cores, 64,000 processor cores, and so forth). It will be appreciated that, although primarily presented with respect to example embodiments in which each of the processors 111 includes only a single core and single associated cache module, any of the processors 111 may include multiple cores and/or multiple associated cache modules.

The processors 111 may be configured to perform various processing functions. The processing functions supported by the processors 111 may depend on the functions supported by the device within which the multi-processor system 100 is disposed. For example, the multi-processor system 100 may be disposed within a computer, a smartphone, a gaming system, an extended reality device, a router, a switch, a server, a packet processing device, a medical device, a supercomputer, or the like. For example, the processing functions supported by the CPU 110 and the processors 111 of the CPU 110 may include general processing functions, video rendering, video editing, extended reality, virtual reality, augmented reality, high speed network communications (e.g., packet forwarding, packet processing, or the like, as well as various combinations thereof), medical imagery processing, cryptocurrency mining, or the like, as well as various combinations thereof. It will be appreciated that the CPU 110 and the processors 111 of the CPU 110 may be configured to support various other types of processing functions, which may depend on the functions supported by the device within which the multi-processor system 100 is disposed.

The processors 111 may be configured to perform processing functions based on storage of program instructions and data for the processing functions. The processors 111 may be configured to store program instructions and data for the processing functions as memory blocks, which may be stored within the main memory 130 via a memory bus 139 between the CPU 110 and the main memory 130 (illustrated as program instructions and data 131 stored within the main memory 130) and locally within cache memory within the CPU 110. The main memory 130 may be a random access memory (RAM), such as a static RAM (SRAM), dynamic RAM (DRAM), high bandwidth memory (HBM), or the like, or other suitable type of main memory. The cache memory within the CPU 110 may include Level 1 (L1) or Level 2 (L2) caches within the processors 111 (as illustrated in FIG. 1), respectively, a Level 3 (L3) cache within the CPU 110 that may be shared by the processors 111 (omitted from FIG. 1 for purposes of clarity), or a combination thereof. It will be appreciated that access to data blocks from processor-side caches is faster than access to data blocks from main memory (e.g., since main memory is typically much slower than the execution speed of a processor, if a memory block needed during execution of a program is found in a cache on the CPU, then the processor can avoid spending a relatively large number of clock cycles to retrieve the memory block from the slower main memory). As indicated above, when a processor resumes its operation after a restart, the execution of program instructions and access to its data would gradually warm up the caches as the result of cache misses (since the processor always looks up the program instructions in the caches and, if not found, then retrieves from main memory), and the cache misses result in slower execution of the program until the caches are warmed up completely, thereby impacting the performance of various applications such as graphics processing, network packet processing (e.g., in the case of packet processing, all packets would suffer higher latency until the caches are warmed up completely), or the like.

The processor 111-1, as indicated above, includes the core 112 and the cache module 113. The cache module 113 includes a cache 115 and a cache warmup engine (CWE) 117. The cache 115 is a 4-way set-associative cache including five sets (denoted as Set 0-Set 4) and four ways (denoted as W1-W4), thereby providing twenty cache lines for use by the core 112 (one of the cache lines is marked as cache line 116 to illustrate that the cache line is the intersection of a set and a way), although it will be appreciated that various other numbers of ways and sets may be supported. The CWE 117 is configured to support fast warmup of the cache 115 for the processor 111-1. The CWE 117 includes a backup agent (BA) 118 and a restore agent (RA) 119. The CWE 117 is configured to control backup and restore of cache lines of the cache 115 using the EEPROM 150. The BA 118 is configured to control storage of cache lines of the cache 115 from the cache 115 into the EEPROM 150 in response to a reset event associated with the processor 111-1 and the RA 119 is configured to control storage of the cache lines of the cache 115 from the EEPROM 150 back into the cache 115 in response to a restart event associated with the processor 111-1. The backup power source 140 is configured to power the cache module 113 long enough to enable the CWE 117 to support backup of the cache lines of the cache 115 in the EEPROM 150 (e.g., to permit the BA 118 of the CWE 117 to store the cache lines of the cache 115 from the cache 115 into the EEPROM 150 in response to a reset event associated with the processor 111-1). The backup power source 140 also may be configured to power any other elements of the CPU 110 (e.g., bus controllers or the like) which may need power in order to support the CWE 117 during backup of the cache lines of the cache 115 into the EEPROM 150. The EEPROM 150 is configured to provide persistent storage of the cache lines of the cache 115 despite a loss of power to the CPU 110 until the RA 119 of the CWE 117 is able to store the cache lines of the cache 115 from the EEPROM 150 back into the cache 115 in response to a restart event associated with the processor 111-1.

The CWE 117, as indicated above, is configured to support fast warmup of the cache 115 for the processor 111-1 based on power from the backup power source 140 and storage space of the EEPROM 150. The backup power source 140 may include any suitable type of power source (e.g., a battery, a capacitor, a supercapacitor, or the like) which may provide power for elements of the CPU 110 involved in backup of the cache lines of the cache 115 in the EEPROM 150 (e.g., the cache module 113 including the cache 115 and the CWE 117, a bus controller(s) of the CPU 110 controlled by the CWE 117 of the cache module 113 during backup of the cache lines of the cache 115 in the EEPROM 150, and so forth). The cache module 113 is connected to the EEPROM 150 through an internal I²C (I2C) bus or Serial Peripheral Interface (SPI) bus denoted as I2C/SPI bus 159, although it will be appreciated that the cache module 113 may be connected to EEPROM 150 using various other types of buses. The CWE 117 includes control logic configured to control communication over the I2C/SPI bus 159 to support fast warmup of the cache 115 for the processor 111-1, where the BA 118 may include controller logic configured to control storage of cache lines from the cache 115 into the EEPROM 150 via the I2C/SPI bus 159 and the RA 119 may include controller logic configured to control storage of cache lines from the EEPROM 150 into the cache 115 via the I2C/SPI bus 159. The BA 118 can read the valid cache lines in the cache 115 and store them into the EEPROM 150 through the I2C/SPI bus 159 during a reset and the RA 119 can read the EEPROM 150 through the I2C/SPI bus 159 and reinstate the preserved cache lines into the cache 115 during a restart. The EEPROM 150 is expected to have a well-known, standard address on the I2C/SPI bus 159. For example, the standard I2C address of an EEPROM device is 0x54, such that any byte location in the EEPROM device is addressed as an offset at the I2C address 0x54. In this case, writing into the N-th byte of EEPROM 150 is translated to the CWE 117 issuing an I2C write operation to offset N in I2C address 0x54 and reading of the N-th byte from EEPROM 150 is translated to the CWE 117 issuing an I2C read operation from offset N in I2C address 0x54. It will be appreciated that, although omitted for purposes of clarity, more than one EEPROM may be used to provide persistent storage for supporting fast warmup of the cache 115 for the processor 111-1.

The CWE 117, as indicated above, is configured to support fast warmup of the cache 115 for the processor 111-1 by controlling backup and restore of cache lines of the cache 115 using the EEPROM 150 via the I2C/SPI bus 159. The CWE 117 may control communication between the cache 115 and the EEPROM 150 over the I2C/SPI bus 159, for supporting backup and restore of cache lines of the cache 115 using the EEPROM 150 via the I2C/SPI bus 159, based on interaction with an I2C/SPI bus controller (omitted for purposes of clarity) configured to control communication over the I2C/SPI bus 159. The CWE 117 may control communication over the I2C/SPI bus 159, for supporting backup and restore of cache lines of the cache 115 using the EEPROM 150 via the I2C/SPI bus 159, based on control of the I2C/SPI bus controller by the BA 118 for backup of the cache lines into the EEPROM 150 and based on control of the I2C/SPI bus controller by the RA 119 for restore of the cache lines from the EEPROM 150. The CWE 117 may control the I2C/SPI bus controller-controlling storage of cache lines from the cache 115 into the EEPROM 150 on backup and controlling storage of cache lines from the EEPROM 150 into the cache 115 on restore—by issuing bus transactions to the I2C/SPI bus controller (e.g., based on writes to one or more registers in the I2C/SPI bus controller) such that the I2C/SPI bus controller can translate the bus transaction into the I2C/SPI bus protocol and issue the bus transaction on the I2C/SPI bus to the EEPROM 150. For example, for storage of cache lines from the cache 115 into the EEPROM 150, the BA 118 may issue bus transactions to the I2C/SPI bus controller, which translates the bus transactions into the I2C/SPI bus protocol and issues the bus transaction on the I2C/SPI bus 159 to the EEPROM 150 for writing the cache lines into the EEPROM 150. For example, for storage of cache lines from the EEPROM 150 into the cache 115, the BA 118 may issue bus transactions to the I2C/SPI bus controller, which translates the bus transactions into the I2C/SPI bus protocol and issues the bus transaction on the I2C/SPI bus 159 to the EEPROM 150 for reading the cache lines from the EEPROM 150 for storage back into the cache 115. It will be appreciated that the CWE 117, including the BA 118 and the RA 119, may control the I2C/SPI bus controller in various other ways for controlling storage of cache lines from the cache 115 into the EEPROM 150 on backup and controlling storage of cache lines from the EEPROM 150 into the cache 115 on restore. It will be appreciated that the I2C/SPI bus 159 also may be considered to represent the capability to move the cache lines between the cache 115 and the EEPROM 150 (e.g., the various bus controllers, logic, interfaces, and so forth).

The CWE 117, as indicated above, may control communication over the I2C/SPI bus 159, for supporting backup and restore of cache lines of the cache 115 using the EEPROM 150 via the I2C/SPI bus 159, based on interaction with an I2C/SPI bus controller (which, again, has been omitted for purposes of clarity). It will be appreciated that the I2C/SPI bus controller for the I2C/SPI bus 159 may be implemented in various ways. For example, the I2C/SPI bus controller may be included within the processor 111-1 (e.g., where the I2C/SPI bus controller and the associated I2C/SPI bus 159 are dedicated for use by the processor 111-1 and the CWE 117 of the processor 111-1) or within the processing unit 110 but external to the processor 111-1 (e.g., where the I2C/SPI bus controller and the associated I2C/SPI bus 159 are shared by multiple processors 111 and the associated CWEs of the multiple processors 111). For example, where the where the I2C/SPI bus controller and the associated I2C/SPI bus 159 are shared by multiple processors 111 and the associated CWEs of the multiple processors 111, the processing unit 110 may further include multi-access orchestration logic configured to support use of the I2C/SPI bus controller and the associated I2C/SPI bus 159 by the multiple processors 111 and the associated CWEs of the multiple processors 111. For example, the I2C/SPI bus controller may be connected to the processor 111-1 via a Peripheral Component Interconnect Express (PCIe) bus which connects the I2C/SPI bus controller to a PCIe root complex in the processor 111-1 (where the PCIe root complex may include the logic to orchestrate multi-access operations for the I2C/SPI bus controller such that only one memory operation (read or write) is permitted at any time). For example, where the I2C/SPI bus controller is controlled based on use of a PCIe bus, the CWE 117 may control bus transactions on the I2C/SPI bus 159 by doing PCIe writes to one or more registers of the I2C/SPI bus controller, which then translates those PCIe writes into the I2C/SPI bus protocol and issues the transactions on the I2C/SPI bus 159 to the EEPROM 150. It will be appreciated that various other implementations of the interface between the cache module 113 and the EEPROM 150 (e.g., various logic and/or components used to support backup and restore of cache lines between the cache 115 and the EEPROM 150 for fast cache warmup) may be utilized.

The CWE 117 includes controller logic configured to control communication over the I2C/SPI bus 159 (e.g., based on interaction with an I2C/SPI bus controller of the I2C/SPI bus 159) to support fast warmup of the cache 115 for the processor 111-1, where the BA 118 may include controller logic configured to control storage of cache lines from the cache 115 into the EEPROM 150 via the I2C/SPI bus 159. The BA 118 will read a cache line, say at {set x, way y} and issue a write operation to persistent memory as {offset, data}, where offset is the offset in persistent memory and data is {key={x,y}, value=cacheline_data}. The operation is sent to persistent memory managing logic in the CWE 117. Here, the term “persistent memory” is used (rather than referring to the EEPROM 150 which is being used as the persistent memory) as the BA 118 does not know whether the persistent memory is an EEPROM (or something similar) and what bus is used to connect to the persistent memory. The CWE 117 is aware that the persistent memory is an EEPROM (namely, EEPROM 150) accessible via an I2C bus (in this description, it is assumed that the I2C/SPI bus 159 is an I2C bus that is controlled by an I2C bus controller). The CWE 117 translates the operation to an I2C bus write transaction as {i2c_address_of_eeprom, offset, data}. The CWE 117 sends the I2C bus write transaction to the I2C bus controller of the CPU 110. The CWE 117 does not send the I2C bus write transaction directly since the I2C bus controller itself is connected over a PCIE bus (PCIE_root_complex_in_CPU<-pcie_bus--->I2C_bus_controller). So, the CWE 117 issues a PCIE write operation to the PCIE root complex of CPU and root complex sends the operation to i2c bus controller. The I2C bus controller executes the I2C write operation over the I2C bus connected to the EEPROM 150. The EEPROM 150 stores the data at the offset. It will be appreciated that the transactions may be specified, communicated, and/or executed in other ways for other types of buses and associated bus controllers.

The CWE 117 includes control logic configured to control communication over I2C/SPI bus 159 (e.g., based on interaction with an I2C/SPI bus controller of the I2C/SPI bus 159) to support fast warmup of the cache 115 for the processor 111-1, where the RA 119 may include controller logic configured to control storage of cache lines from the EEPROM 150 into the cache 115 via the I2C/SPI bus 159. The RA 119 will issue a read operation to persistent memory from {offset}, where {offset} is the offset in persistent memory. The operation is sent to persistent memory managing logic in the CWE 117. Here, the term “persistent memory” is used (rather than referring to the EEPROM 150 which is being used as the persistent memory) as the BA 118 does not know whether the persistent memory is an EEPROM (or something similar) and what bus is used to connect to the persistent memory. The CWE 117 translates the operation to an I2C bus read transaction as {i2c_address_of_eeprom, offset}. The CWE 117 sends the I2C bus read transaction to the I2C bus controller of the CPU 110. The CWE 117 does not send the I2C bus read transaction since the I2C bus controller itself is connected over a PCIE bus (PCIE_root_complex_in_CPU<-pcie_bus--->I2C_bus_controller). So, the CWE 117 issues a PCIE read operation to the PCIE root complex of CPU 110 and root complex sends the operation to I2C bus controller. The I2C bus controller executes the I2C read operation over the I2C bus connected to the EEPROM 150. The EEPROM 150 responds by sending back the data unit at offset. The I2C bus controller receives the data and sends to the data to the CWE 117 over the PCIE bus. The CWE 117 sends the data to RA 119. The RA 119 unpacks the data as key-value, where the key has the set and way of the cache, so the RA 119 stores the value into the cache line.

It will be appreciated that the multi-processor system 100, although primarily presented with respect to specific types, numbers, and arrangements of elements, may be configured to support various other types, numbers, and/or arrangements of elements. For example, although primarily presented with respect to example embodiments in which the CPU 110 is configured such that each of the processors 111 includes an on-board cache (which may include one or more L1 caches, one or more L2 caches, or combinations thereof), respectively, the CPU 110 alternatively or also may include one or more L3 caches which may be shared by the processors 111 in various ways (i.e., the cache module 113, although primarily depicted as representing an on-board cache of the processor 111-1, may represent a portion of a larger cache module that includes a combination of L1/L2 caches and one or more L3 caches used by processor 111-1, a portion of a larger cache module that includes L1/L2 caches and/or L3 caches of multiple processors 111 or all of the processors 111, or the like). For example, the backup power source 140 may be dedicated for use by the processor 111-1 or may be configured to support multiple processors 111 or even all of the processors 111 (e.g., there may be a dedicated backup power source for each processor 111, there may be M backup power sources for the N processors where M<N, or the like). For example, the EEPROM 150 may be dedicated for use by the processor 111-1 or may be configured to support multiple processors 111 or even all of the processors 111, multiple EEPROMs may be provided for each of the processors 111 (e.g., two EEPROMS for each processor 111, four EEPROMs for each processor 111, or the like). For example, if the EEPROM 150 is shared between multiple processors 111, then each processor 111 may be assigned a designated location, respectively, within the EEPROM 150 to store the contents of its cache. For example, although primarily presented with respect to use of EEPROM 150 as the persistent memory, various other types of persistent memories may be used. For example, although primarily presented with respect to use of I2C/SPI bus 159 as the bus between the cache module 113 and the EEPROM 150, various other types of buses may be used between the cache module 113 and the EEPROM 150. It will be appreciated that the multi-processor system 100 may be configured to support various other types, numbers, and/or arrangements of elements for supporting fast cache warmup in response to a cold or warm reset/restart events associated with the multi-processor system 100.

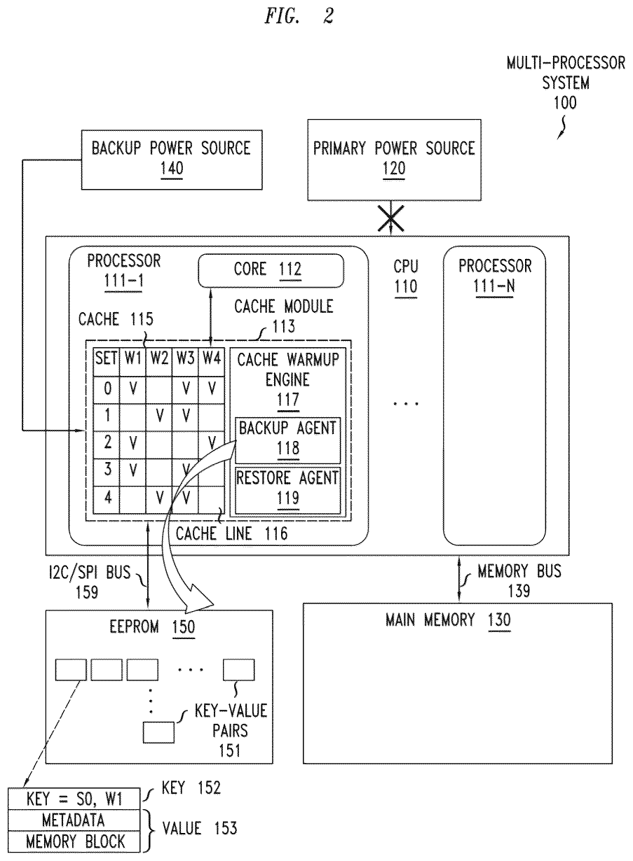

As illustrated in FIG. 1, the multi-processor system 100 of FIG. 1 is depicted for purposes of illustrating the state of the multi-processor system 100 under normal operation. Here, during execution of the program by the processor 111-1, the processor 111-1 has cached the frequently used program instructions and program data 131 from main memory 130 into the cache 115 as memory blocks. In this example, valid cache lines of the cache 115 including such memory blocks are marked with a “V” (illustratively, the cache lines {S0, W1}, {S0, W3}, {S0, W4}, {S1, W2}, {S1, W3}, {S2, W1}, {S2, W4}, {S3, W1}, {S3, W3}, {S4, W2}, and {S4, W3} are valid cache lines within the cache 115). The CPU 110 is operating based on the power from the primary power source 120, so the cache 115 has not been backed up into the EEPROM 150, although the backup power source 140 and the EEPROM 150 are available to protect the contents of the cache 115 in the event of a reset event associated with the CPU 110. In this manner, multi-processor system 100 is configured to support fast warmup of the cache 115 of the processor 111-1 of the CPU 110 in response to a cold or warm reset/restart of the CPU 110. It will be appreciated that operation of the multi-processor system 100 to support fast warmup of the cache 115 of the processor 111-1 of the CPU 110 in response to a cold or warm reset/restart of the CPU 110 may be further understood by way of reference to FIGS. 2-5, which illustrate the state of the multi-processor system 100 at different points in the process for supporting fast warmup of the cache 115 of the processor 111-1 of the CPU 110 in response to a cold reset/restart of the CPU 110.

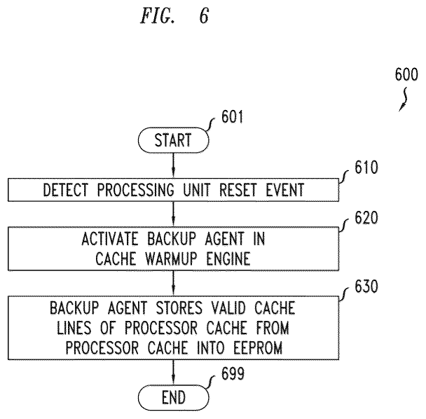

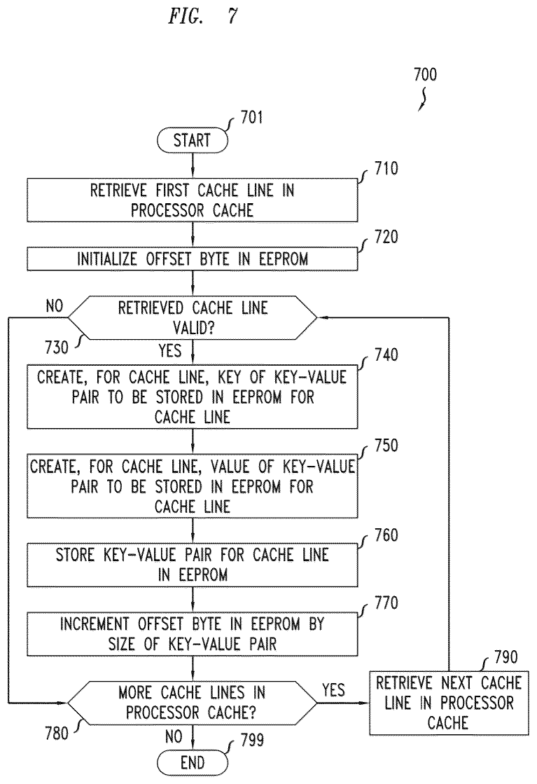

FIG. 2 depicts an example embodiment of the multi-processor system of FIG. 1 for illustrating the state of the multi-processor system during storing of contents of the processor cache from the processor cache into the persistent memory based on the reset of the processing unit. As illustrated in FIG. 2, the multi-processor system 100 of FIG. 1 is depicted for purposes of illustrating the state of the multi-processor system 100 during a cold reset of the CPU 110. In FIG. 2, the multi-processor system 100 has lost power (illustrated by the “X” through the line from the primary power source 120 to the CPU 110), with the exception of elements of the CPU 110 powered by the backup power source 140 (e.g., the cache module 113, any bus controllers of the CPU 110, or the like). The main memory 130 is shown as being empty has it has no power to maintain its state. The BA 118 in the CWE 117 is activated for controlling storage of cache lines of the cache 115 from the cache 115 into the EEPROM 150. The BA 118 reads the valid cache lines in the cache 115 and stores the valid cache lines into the EEPROM 150 through the I2C/SPI bus 159. The cache lines are stored in the EEPROM 150 as key-value pairs and, as such, can be stored sequentially in the EEPROM 150. Namely, each valid cache line in cache 115 will have a corresponding key-value pair 151 in the EEPROM 150 (illustrated as the boxes within the EEPROM 150 labeled as key-value pairs 151, with the details of the key-value pair 151 for the cache line in Set 0-Way 1 being depicted and the details of the other key-value pairs 151 being omitted for purposes of clarity), where the key-value pair 151 includes a key 152 that identifies the location of the cache line within the cache 115 (e.g., set and way values) and a value 153 that includes the data from the cache line (e.g., including the memory block, metadata, or any other information which may be stored within the cache line). The backup power source 140 will have enough power to complete this process of storing the valid cache lines from the cache 115 into the EEPROM 150 through the I2C/SPI bus 159. It will be appreciated that the process for storing the valid cache lines from the cache 115 into the EEPROM 150 may be further understood by way of reference to FIG. 6 and FIG. 7.

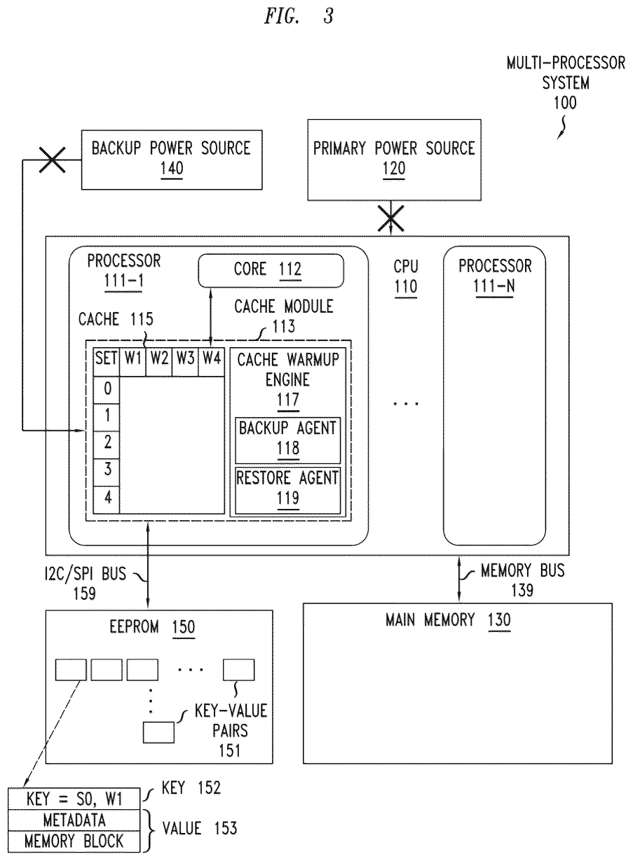

FIG. 3 depicts an example embodiment of the multi-processor system of FIG. 1 for illustrating the state of the multi-processor system after the storing of contents of the processor cache from the processor cache into the persistent memory based on the reset of the processing unit. As illustrated in FIG. 3, the multi-processor system 100 of FIG. 1 is depicted for purposes of illustrating the state of the multi-processor system 100 after the cold reset of the CPU 110, after completion of storage of the valid cache lines of the cache 115 into the EEPROM 150, and after subsequent loss of the backup power source 140 (illustrated by the “X” through the line from the backup power source 140 to the cache module 113). It will be appreciated that, depending on the duration of the cold reset of the CPU 110 and the type of backup power source 140 being used, the backup power source 140 may or may not be depleted before the restart of the CPU 110 is initiated. In FIG. 3, after subsequent loss of the backup power source 140, the entire multi-processor system 100 is out of power and has lost all dynamic states and, thus, the cache 115 is shown as being empty as the cache 115 no longer has power to maintain its states. However, despite the loss of the information in the cache 115, the cache lines 115 has been preserved in the EEPROM 115 as the EEPROM 115 is a persistent memory configured to maintain state even without power.

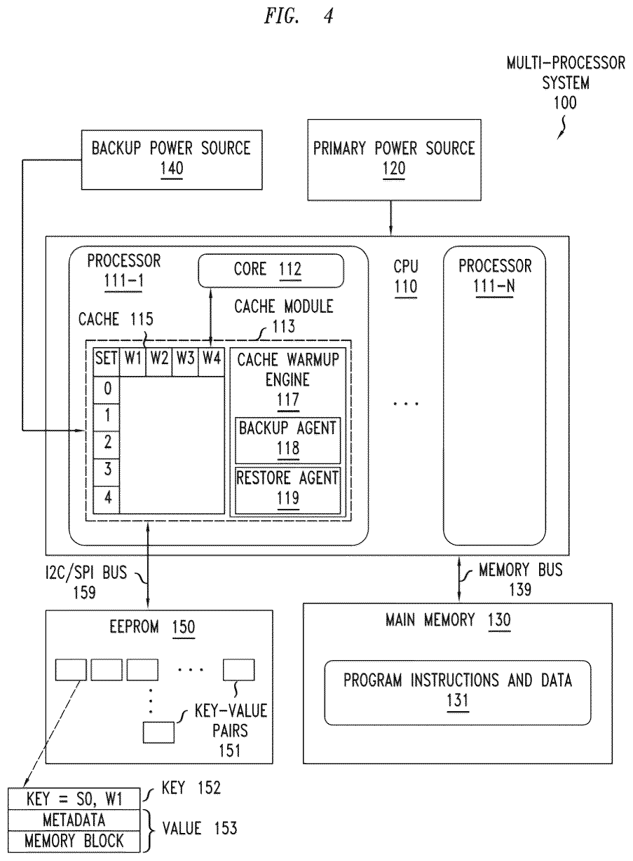

FIG. 4 depicts an example embodiment of the multi-processor system of FIG. 1 for illustrating the state of the multi-processor system before the storing of contents of the processor cache from the persistent memory into the processor cache based on the restart of the processing unit. As illustrated in FIG. 4, the multi-processor system 100 of FIG. 1 is depicted for purposes of illustrating the state of the multi-processor system 100 during a restart of the CPU 110. In FIG. 4, the multi-processor system 100 has been powered up (the “X” through the line from the primary power source 120 to the CPU 110 is no longer depicted). The program instructions and data 131 have been restored in the main memory 130, however, the cache lines of the cache 115 are still being stored as key-value pairs in the EEPROM 150 and have not yet been restored in to the cache 115 so the cache 115 is still empty.

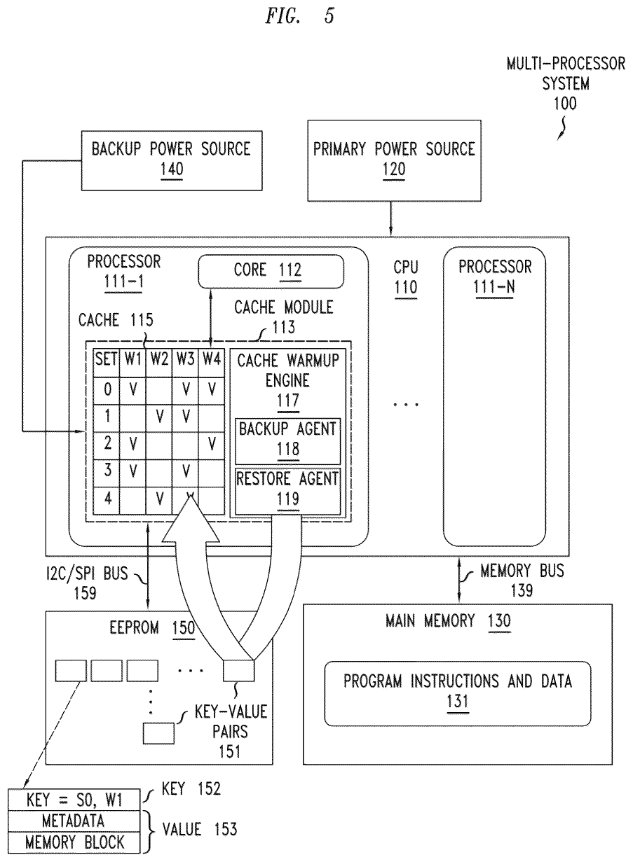

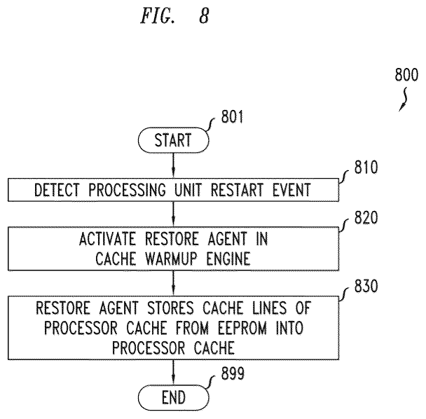

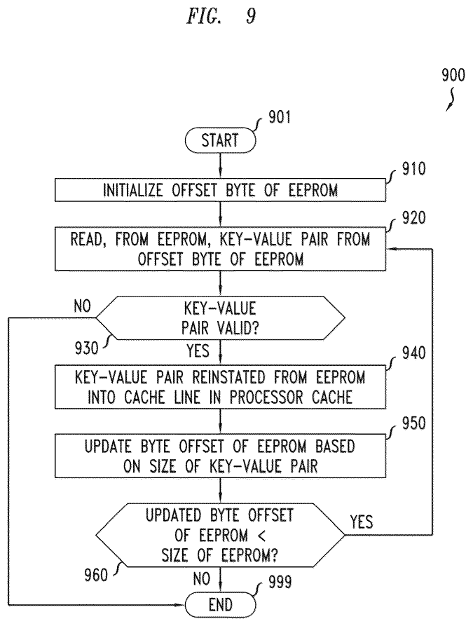

FIG. 5 depicts an example embodiment of the multi-processor system of FIG. 1 for illustrating the state of the multi-processor system during storing of contents of the processor cache from the persistent memory into the processor cache based on the restart of the processing unit. As illustrated in FIG. 5, the multi-processor system 100 of FIG. 1 is depicted for purposes of illustrating the state of the multi-processor system 100 after a restart of the CPU 110. The RA 119 in the CWE 117 is activated for controlling storage of the cache lines of the cache 115 from the EEPROM 150 into the cache 115. The RA 119 restores the cache lines from the EEPROM 150 into the cache 115. The RA 119 sequentially reads the key-value pair entries in the EEPROM 150 through the I2C/SPI bus 159 and reinstates the key-value pair entries into the corresponding cache lines in the cache 115, respectively. In the key-value pair for a cache line, the key identifies the location of the cache line within the cache 115 (e.g., set and way values) and the value that includes the data from the cache line (e.g., including the memory block, metadata, or any other information which may be stored within the cache line), such that the value of the key-value pair may be stored into the cache line indicated by the key of the key-value pair. It will be appreciated that the process for restoring the valid cache lines from the EEPROM 150 into the cache 115 may be further understood by way of reference to FIG. 8 and FIG. 9.

It will be appreciated that, after completion of post-initialization which results in restoration of the state of the cache 115, the processor 111-1 starts execution of the program. At this point, the state of the cache 115 is the same as before the power outage. It is noted that the reinstated cache lines will correspond to the memory blocks in the main memory 130 as long as the memory blocks in the main memory 130 hold the same content as before the power outage. This condition will be true for the program instructions since the program instructions have fixed addresses in the main memory 130. This condition also may be true for at least some types of data, such as packet forwarding tables in network processors as the packet forwarding tables are loaded at fixed addresses in the main memory 130. In at least some example embodiments, the metadata of the cache lines may be configured to indicate whether memory blocks held by the cache lines have volatile addressing (meaning that the memory blocks may be relocated in the main memory 130 after the system is reset and any cache lines for which the metadata indicates volatile addressing will not be preserved in the EEPROM 150.

FIG. 6 depicts an example embodiment of a method for use by a cache warmup engine to store cache lines of a processor cache of the processing unit from the processor cache into a persistent memory. It will be appreciated that, although primarily presented with respect to use of an EEPROM as the persistent memory, other types of persistent memories may be used. It will be appreciated that, although primarily presented herein as being performed serially, at least a portion of the functions of method 600 may be performed contemporaneously or in a different order than as presented in FIG. 6. At block 601, the method 600 begins. At block 610, a processing unit reset event is detected for a processing unit including a processor cache. The processing unit reset event indicates that the processing unit has been reset, either as a cold reset or a warm reset. At block 620, the backup agent in the cache warmup engine is activated. At block 630, the backup agent stores valid cache lines of the processor cache from the processor cache into the EEPROM. The backup agent may store the cache lines of the processor cache from the processor cache into the EEPROM as key-value pairs including keys identifying the cache lines and values including the contents of the cache lines. At block 699, the method 600 ends.

FIG. 7 depicts an example embodiment of a method for use by a backup agent of a cache warmup engine of a processing unit to store cache lines of a processor cache of the processing unit from the processor cache into a persistent memory. It will be appreciated that the method 700 of FIG. 7 may be used to implement the block 630 of FIG. 6. It will be appreciated that, although primarily presented with respect to use of an EEPROM as the persistent memory, other types of persistent memories may be used. It will be appreciated that, although primarily presented herein as being performed serially, at least a portion of the functions of method 700 may be performed contemporaneously or in a different order than as presented in FIG. 7. At block 701, the method 700 begins. At block 710, the first cache line in the processor cache is retrieved. At block 720, the offset byte in the EEPROM is initialized to point to the first byte location in the EEPROM for the processor (e.g., initialized to 0 where the EEPROM exclusively stores the processor cache for one processor only or initialized to point to the first byte in the location designated for the processor if the EEPROM is to be shared between multiple processors). At block 730, a determination is made as to whether the retrieved cache line is valid. If the retrieved cache line is valid then the method 700 proceeds to block 740, otherwise if the retrieved cache line is not valid then the method 700 proceeds to block 780. At block 740, the key, of the key-value pair to be stored in the EEPROM for the cache line, is created for the cache line. The key is formed as a tuple that includes the set number and the way number of the cache line ({set number, way number}). At block 750, the value, of the key-value pair to be stored in the EEPROM for the cache line, is created for the cache line. The value is formed such that the value includes the memory block stored in the cache line and metadata of the cache line (e.g., tags, indicators, offsets, or the like). At block 760, the key-value pair for the cache line is stored in the EEPROM at the byte offset. At block 770 the offset byte in the EEPROM incremented by the size of the stored key-value pair. The offset byte now points to the location for storing the key-value pair for the next cache line. At block 780, a determination is made as to whether there are more cache lines in the processor cache that have not yet been processed. If there are more cache lines in the processor cache then the method 700 proceeds to block 790, otherwise if there are no more cache lines in the processor cache then the method 700 proceeds to block 799 where the method 700 ends. At block 790, the next line in the processor cache is retrieved, and then the method 700 returns to block 730 for processing of the next cache line. At block 799, the method 700 ends.

FIG. 8 depicts an example embodiment of a method for use by a cache warmup engine to reinstate cache lines of a processor cache of the processing unit from a persistent memory into the processor cache. It will be appreciated that, although primarily presented with respect to use of an EEPROM as the persistent memory, other types of persistent memories may be used. It will be appreciated that, although primarily presented herein as being performed serially, at least a portion of the functions of method 800 may be performed contemporaneously or in a different order than as presented in FIG. 8. At block 801, the method 800 begins. At block 810, a processing unit restart event is detected for a processing unit including a processor cache. The processing unit restart event indicates that the processing unit has been initialized. At block 820, the restore agent in the cache warmup engine is activated. At block 830, the restore agent stores cache lines of the processor cache from the EEPROM into the processor cache. The restore agent may store the cache lines of the processor cache from the EEPROM into the processor cache by reading key-value pairs from the EEPROM. At block 899, the method 800 ends.

FIG. 9 depicts an example embodiment of a method for use by a restore agent of a cache warmup engine of a processing unit to reinstate cache lines of a processor cache of the processing unit from a persistent memory into the processor cache. It will be appreciated that the method 900 of FIG. 9 may be used to implement the block 830 of FIG. 8. It will be appreciated that, although primarily presented with respect to use of an EEPROM as the persistent memory, other types of persistent memories may be used. It will be appreciated that, although primarily presented herein as being performed serially, at least a portion of the functions of method 900 may be performed contemporaneously or in a different order than as presented in FIG. 9. At block 901, the method 900 begins. At block 910, the offset byte of the EEPROM is initialized to point to the first byte location in the EEPROM for the processor (e.g., initialized to 0 where the EEPROM exclusively stores the processor cache for one processor only or initialized to point to the first byte in the location designated for the processor if the EEPROM is to be shared between multiple processors). At block 920, the key-value pair associated with the offset byte is read from the EEPROM. At block 930, a determination is made as to whether the key-value pair is valid. If the key-value pair is valid then the method 900 proceeds to block 940, otherwise if the key-value pair is not valid then the method 900 proceeds to block 999 where the method 900 ends. At block 940, the key-value pair is reinstated from the EEPROM into the corresponding cache line in the processor cache. The cache line is identified from the set number and way number values in the key, and the memory block and metadata of the cache line are read from the value. This may be represented as reinstate V->memory-block and V->meta-data into cache line at {K->Set, K->Way}. At block 950, the offset byte of the EEPROM is updated based on the size of the key-value pair (e.g., the byte offset value is increased by the size of the key-value pair. This may be represented as EEPROM-offset=EEPROM-offset+size-of-KV. At block 960, a determination is made as to whether the updated offset byte of the EEPROM is less than the size of the EEPROM. It is noted that, here, an assumption is that the EEPROM exclusively stores the cache for the processor only (whereas, if the EEPROM is to be shared between multiple processors, then a determination would be made as to whether the updated offset byte of the EEPROM is less than the size of the area of the EEPROM designated for the processor). If the updated offset byte of the EEPROM is less than the size of the EEPROM then the method 900 returns to block 920, otherwise if the updated offset byte of the EEPROM is not less than the size of the EEPROM then the method 900 proceeds to block 999 where the method 900 ends. At block 999, the method 900 ends.

It will be appreciated that, although primarily presented herein with respect to supporting fast cache warmup within a particular type of multi-processor system supporting a particular type of processing unit (namely, a CPU) and a particular number of persistent memory (namely, an EEPROM), fast cache warmup may be supported within various other types of multi-processor system, including multi-processor systems supporting other types of processing units having caches for which fast cache warmup may be supported (e.g., graphic processing units (GPUs) network processing units (NPUs), or the like, as well as various combinations thereof), multi-processor systems supporting other types of persistent memory for use in storing cache lines of caches for which fast cache warmup may be supported (e.g., an HDD, an SSD, an SD card, an eMMC card, or the like, as well as various combinations thereof), or the like, as well as various combinations thereof.

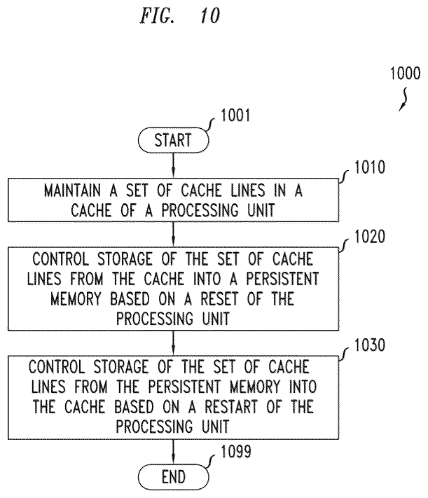

FIG. 10 depicts an example embodiment of a method for supporting fast warmup of a processor cache of a processing unit, based on use of a persistent memory, when the processing unit resets and restarts. It will be appreciated that, although primarily presented herein as being performed serially, at least a portion of the functions of method 1000 may be performed contemporaneously or in a different order than as presented in FIG. 10. At block 1001, the method 1000 begins. At block 1010, maintain a set of cache lines in a cache of a processing unit. At block 1020, control storage of the set of cache lines from the cache into a persistent memory based on a reset of the processing unit. At block 1030, control storage of the set of cache lines from the persistent memory into the cache based on a restart of the processing unit. At block 1099, the method 1000 ends.

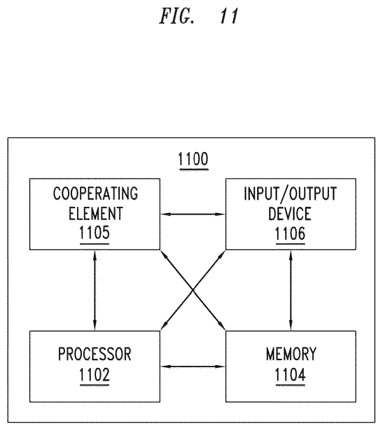

FIG. 11 depicts an example embodiment of a computer suitable for use in performing various functions presented herein.

The computer 1100 includes a processor 1102 (e.g., a central processing unit (CPU), a graphics processing unit (GPU), a network processing unit (NPU), a processor, a processor core of a processor, a subset of processor cores of a processor, a set of processor cores of a processor, or the like) and a memory 1104 (e.g., a random access memory (RAM), a read-only memory (ROM), or the like). In at least some example embodiments, the computer 1100 may include at least one processor and at least one memory storing instructions that, when executed by the at least one processor, cause the computer 1100 to perform various functions presented herein.

The computer 1100 also may include a cooperating element 1105. The cooperating element 1105 may be a hardware device. The cooperating element 1105 may include firmware. The cooperating element 1105 may be a process that can be loaded into the memory 1104 and executed by the processor 1102 to implement various functions presented herein (in which case, for example, the cooperating element 1105 (including associated data structures) can be stored on a non-transitory computer readable medium, such as a storage device or other suitable type of storage element (e.g., a magnetic drive, an optical drive, or the like)).

The computer 1100 also may include one or more input/output devices 1106. The input/output devices 1106 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 1100 may represent a general architecture and functionality suitable for implementing functional elements described herein, portions of functional elements described herein, or the like, as well as various combinations thereof. For example, computer 1100 may provide a general architecture and functionality that is suitable for implementing one or more elements presented herein or may provide a general architecture and functionality within which one or more elements presented herein may be utilized.

It will be appreciated that at least some of the functions presented herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits, and/or any other hardware equivalents).

It will be appreciated that at least some of the functions presented herein may be implemented within hardware, for example, as circuitry that cooperates with the processor to perform various functions. Portions of the functions/elements described herein may be implemented as a computer program product where computer instructions, when processed by a computer, adapt the operation of the computer such that the methods and/or techniques described herein are invoked or otherwise provided. Instructions for invoking the various methods may be stored in fixed or removable media (e.g., non-transitory computer readable media), transmitted via a data stream in a broadcast or other signal bearing medium, and/or stored within a memory within a computing device operating according to the instructions.

It will be appreciated that the term “non-transitory” as used herein is a limitation of the medium itself (i.e., tangible, not a signal) as opposed to a limitation of data storage persistency (e.g., RAM versus ROM).

It will be appreciated that, as used herein, “at least one of<a list of two or more elements>” and “at least one of the following: <a list of two or more elements>” and similar wording, where the list of two or more elements are joined by “and” or “or”, mean at least any one of the elements, or at least any two or more of the elements, or at least all the elements.

It will be appreciated that, as used herein, the term “or” refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

1-25. (canceled)

26. An apparatus, comprising:
a processing unit comprising:
a cache configured to store a set of cache lines; and
a controller configured to control storage of the set of cache lines from the cache into a persistent memory based on a reset of the processing unit and control storage of the set of cache lines from the persistent memory into the cache based on a restart of the processing unit.

27. The apparatus of claim 26, wherein the processing unit comprises a processor, wherein the cache is disposed on the processor.

28. The apparatus of claim 26, wherein the processing unit comprises a set of multiple processors, wherein the cache is configured to be shared by the set of multiple processors.

29. The apparatus of claim 26, wherein the cache comprises at least one of a Level 1 (L1) cache, a Level 2 (L2) cache, or a Level 3 (L3) cache.

30. The apparatus of claim 26, wherein the storage of the set of cache lines from the cache into the persistent memory and the storage of the set of cache lines from the persistent memory into the cache are controlled based on a communication bus.

31. The apparatus of claim 30, wherein the communication bus includes an I²C (I2C) bus or a Serial Peripheral Interface (SPI) bus.

32. The apparatus of claim 30, wherein the storage of the set of cache lines from the cache into the persistent memory and the storage of the set of cache lines from the persistent memory into the cache are controlled based on interaction by the controller with a bus controller of the communication bus.

33. The apparatus of claim 26, further comprising the persistent memory, wherein the persistent memory is configured to:
receive the set of cache lines from the processing unit based on the reset of the processing unit;
store the set of cache lines from the cache; and
send the set of cache lines to the processing unit based on the restart of the processing unit.

34. The apparatus of claim 26, further comprising:
a main memory configured to store instructions and data for the processing unit.

35. The apparatus of claim 26, further comprising:
a power source configured to power the processing unit, wherein the storage of the set of cache lines from the cache into the persistent memory is initiated based on an unavailability of the power source and the storage of the set of cache lines from the persistent memory into the cache is initiated based on an availability of the power source.

36. The apparatus of claim 26, further comprising:
a backup power source configured to power the cache and the controller during the storage of the set of cache lines from the cache into the persistent memory.

37. The apparatus of claim 36, wherein the backup power source comprises a battery, a capacitor, or a supercapacitor.

38. The apparatus of claim 26, wherein the persistent memory comprises at least one of an electrically erasable programmable read only memory (EEPROM), a hard disk drive (HDD), a solid state drive (SSD), a secure digital (SD) card, or an embedded multimedia (eMMC) card.

39. The apparatus of claim 26, wherein the set of cache lines is stored in the persistent memory as a set of key-value pairs, respectively, wherein, for each cache line in the set of cache lines, the respective key-value pair for the respective cache line includes a key identifying a respective location of the respective cache line within the cache and a value comprising a respective set of contents of the respective cache line within the cache.

40. The apparatus of claim 39, wherein the respective set of contents of the respective cache line comprises a respective memory block of the respective cache line and a respective set of metadata of the respective cache line.

41. The apparatus of claim 26, wherein, to control the storage of the set of cache lines from the cache into the persistent memory based on the reset of the processing unit, the controller is configured to:
for each cache line in the set of cache lines:
create a key indicative of a location of the cache line within the cache;
create a value including contents of the cache line;
control storage of the key and the value in the persistent memory as a key-value pair for the cache line at a location within the persistent memory that is based on an offset byte parameter of the persistent memory; and
increment the offset byte parameter of the persistent memory by a size of the key-value pair for the cache line.

42. The apparatus of claim 26, wherein, to control the storage of the set of cache lines from the persistent memory into the cache based on the restart of the processing unit, the controller is configured to:
for each cache line in the set of cache lines:
access a key-value pair for the cache line from a location within the persistent memory that is based on an offset byte parameter of the persistent memory;
determine, from a key of the key-value pair, a location of the cache line within the cache;
store, based on the location of the cache line within the cache, a value of the key-value pair from the persistent memory into the cache line within the cache; and
increment the offset byte parameter of the persistent memory by a size of the key-value pair for the cache line.

43. The apparatus of claim 26, wherein the set of cache lines comprises a subset of available cache lines of the cache satisfying a condition.

44. The apparatus of claim 43, wherein the condition comprises metadata of a given cache line being indicative that a memory block held by the given cache line has nonvolatile addressing that prevents relocation of the memory block in a main memory after the reset of the processing unit.

45. The apparatus of claim wherein the condition is true for at least one of a program instruction or a packet forwarding table.

46. The apparatus of claim 26, wherein the controller comprises a cache warmup engine configured to control the storage of the set of cache lines from the cache into the persistent memory based on the reset of the processing unit and control the storage of the set of cache lines from the persistent memory into the cache based on the restart of the processing unit.

47. The apparatus of claim 46, wherein the cache warmup engine comprises:
a backup agent configured to control the storage of the set of cache lines from the cache into the persistent memory based on the reset of the processing unit; and
a restore agent configured to control the storage of the set of cache lines from the persistent memory into the cache based on the restart of the processing unit.

48. The apparatus of claim 26, wherein the processing unit comprises a central processing unit (CPU), a graphics processing unit (GPU), or a network processing unit (NPU).

49. A method, comprising:
maintaining a set of cache lines in a cache of a processing unit;
controlling storage of the set of cache lines from the cache into a persistent memory based on a reset of the processing unit; and
controlling storage of the set of cache lines from the persistent memory into the cache based on a restart of the processing unit.

50. An apparatus, comprising:
a processing unit comprising a cache configured to store a set of cache lines and a controller configured to control backup of the set of cache lines of the cache;
a primary power source configured to power the processing unit;
a backup power source configured to power the cache and the controller based on the primary power source being unavailable; and
a persistent memory configured to provide a persistent backing store for the cache;
wherein the controller is configured to control storage of the set of cache lines from the cache into the persistent memory based on a reset of the processing unit and control storage of the set of cache lines from the persistent memory into the cache based on a restart of the processing unit.
